(19) United States
(12) Patent Application Publication
(10) Pub. No.: US 2005/0110822 A1
(43) Pub. Date: May 26, 2005

(54) Printing medium discriminator and inkjet printer including the same

(76) Inventors: Ho-bin Hwang, Suwon-si (KR); Young-jung Yun, Suwon-si (KR)

Correspondence Address: STANZIONE & KIM, LLP, 1740 N STREET, N.W., FIRST FLOOR, WASHINGTON, DC, 20036, US

(21) Appl. No.: 10/979,231

(22) Filed: Nov. 3, 2004

(30) Foreign Application Priority Data
Nov. 20, 2003 (KR) 2003-82653

(51) Int. Cl. B41J 29/393

(52) U.S. Cl. 347/19; 400/708

(57) ABSTRACT

An inkjet printer including a printing medium discriminator discriminates a type of a sheet of paper. The printing medium discriminator includes a media sensor separated by a predetermined height from the sheet of paper, to radiate light onto the sheet of paper and to receive light reflected from the sheet of paper, and a vertical movement unit to adjust a vertical height between the media sensor and the sheet of paper.

### CROSS-REFERENCE TO RELATED APPLICATIONS

This application claims the priority of Korean Patent Application No. 2003-82653, filed on Nov. 20, 2003, in the Korean Intellectual Property Office, the disclosure of which is incorporated herein in its entirety by reference.

### BACKGROUND OF THE INVENTION

1. Field of the Invention

The present general inventive concept relates to a printing medium discriminator and an inkjet printer including the same, and more particularly, to an apparatus to effectively discriminate types of printing media fed into a printer.

2. Description of the Related Art

FIG. 1 shows a configuration of a conventional media sensor disclosed in U.S. Pat. No. 5,139,339. Referring to FIG. 1, the media sensor 10 includes a light source 11 emitting light onto a sheet of paper 15 and first and second light receivers 12 and 13 detecting the light.

The first light receiver 12 is centered between the light source 11 and the second light receiver 13 directly above the sheet of paper 15, which is a printing medium, and receives the light reflected diffusedly from the sheet of paper 15. The second light receiver 13 receives the light reflected regularly from the sheet of paper 15 at an angle of reflection as large as its angle of incidence of the light emitted by the light source 11.

In a printer (not shown), the sheet of paper 15, stored in a feeding cassette (not shown), is supplied to a printing unit (not shown) via a paper path. The light source 11 of the media sensor 10 emits the light onto the sheet of paper 15. The first light receiver 12 and the second light receiver 13 receive the light reflected from the sheet of paper 15. Then, the first light receiver 12 and the second light receiver 13 discriminate plain paper from transparent paper according to the intensity of the light.

A recording medium discriminator including a plurality of light sources and a plurality of light receivers is disclosed in the U.S. Pat. No. 5,764,251. The recording medium discriminator requires a plurality of light receivers to receive light reflected from a sheet of paper over a range of angles.

### SUMMARY OF THE INVENTION

In order to solve the foregoing and/or other problems, it is an aspect of the present general inventive concept to provide a printing medium discriminator including a media sensor in which a single light receiver receives both diffusedly reflected light and regularly reflected light from a light source. It is another aspect of the present general inventive concept to provide an inkjet printer including the printing medium discriminator.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a print medium discriminator to discriminate a type of a sheet of paper, the print medium discriminator including a media sensor separated by a predetermined height from the sheet of paper, radiating light onto the sheet of paper, and receiving the light reflected from the sheet of paper, and a vertical movement unit to adjust a vertical height between the media sensor and the sheet of paper.

In an aspect of the present general inventive concept, the media sensor may include a light source to radiate the light onto the sheet of paper at a predetermined angle and a light receiver to receive the light reflected from the sheet of paper. The light receiver may receive diffusedly reflected light and regularly reflected light, respectively, reflected from the sheet of paper according to the vertical height between the media sensor and the sheet of paper adjusted by the vertical movement unit.

In another aspect of the present general inventive concept, the light receiver may be one light receiving element fixedly coupled to the media sensor. The vertical movement unit may move the sheet of paper vertically with respect to the media sensor or vertically move the media sensor toward the sheet of paper.

The foregoing and/or other aspects and advantages of the present general inventive concept may also be achieved by providing an inkjet printer including a printing medium discriminator including an inkjet cartridge mounted on a carriage, the carriage and the inkjet cartridge shuttling in a main scanning direction, a feeding roller to move a sheet of paper in a sub scanning direction, a paper guide separated from the inkjet cartridge by a predetermined height to support the sheet of paper fed from the feeding roller such that the sheet of paper under the inkjet cartridge is in a flat state, a media sensor attached to the inkjet cartridge and separated by a predetermined height from the sheet of paper to radiate light onto the sheet of paper and to receive the light reflected from the sheet of paper, and a vertical movement unit to adjust a vertical height between the media sensor and the sheet of paper.

In an aspect of the present general inventive concept, the vertical movement unit may include a cylinder rod disposed in a slit formed in the main scanning direction at the paper guide and an actuator to move the cylinder rod vertically. The media sensor may be disposed on a side of the inkjet cartridge to face the feeding roller, and the vertical movement unit is installed directly below the media sensor.

In another aspect of the present general inventive concept, the vertical movement unit may include a linear guide vertically disposed on a side of the inkjet printer and an actuator to vertically move the media sensor. The media sensor may be disposed on the linear guide. The media sensor may be a print alignment sensor disposed on a side of the inkjet cartridge to correspond to the main scanning direction.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a configuration of a conventional media sensor;

FIG. 2 is a view illustrating an operation of a printing medium discriminator according to according to an embodiment of the present general inventive concept;

FIG. 3 is a plan view illustrating a configuration of a portion of an inkjet printer including the printing medium discriminator of FIG. 2;

FIG. 4 is a graph illustrating a voltage output from a light receiver of a media sensor, while the media discriminator of FIG. 3 attached to one side of an inkjet cartridge of FIG. 3 is moving in a main scanning direction;

FIG. 5 is a side view illustrating a portion of an inkjet printer including a printing medium discriminator according to another embodiment of the present general inventive concept; and

FIG. 6 is a side view illustrating a portion of an inkjet printer including a printing medium discriminator according to another embodiment of the present general inventive concept.

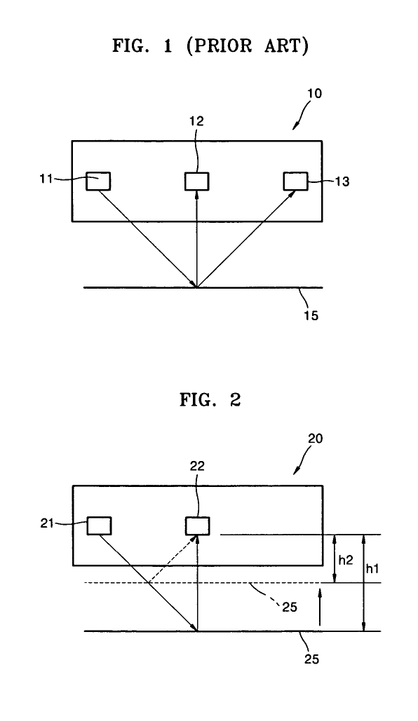

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a view illustrating an operation of a printing medium discriminator according to an embodiment of the present general inventive concept. Referring to FIG. 2, a media sensor 20 may include a light source 21 to emit light and a light receiver 22 to receive reflected light from a sheet of paper 25. In a case where there is a first distance h₁ between a surface of the sheet of paper 25 and the light receiver 22, the light source 21 can radiate the light onto the sheet of paper 25 at a predetermined angle, and some of the light diffusedly reflected from the sheet of paper 25 can be incident on the light receiver 22. The light receiver 22 can generate a current or a voltage to indicate the intensity of the diffusedly reflected light.

In a case where a position of the light receiver 22 is fixed with respect to the sheet of paper 25, if the sheet of paper 25 is moved upward by a predetermined distance until there is a second distance h₂ between the sheet of paper 25 and the light receiver 22, the light regularly reflected from the surface of the sheet of paper 25 can be incident on the light receiver 22, and the light receiver 22 can generate a second current or a second voltage to indicate the intensity of the regularly reflected light.

In FIG. 2, the sheet of paper 25 can be moved upward to adjust a distance between the sheet of paper 25 and the light receiver 22. The media sensor 20 may also be moved downward to adjust the distance between the light receiver 22 of the media sensor 20 and the sheet of paper 25.

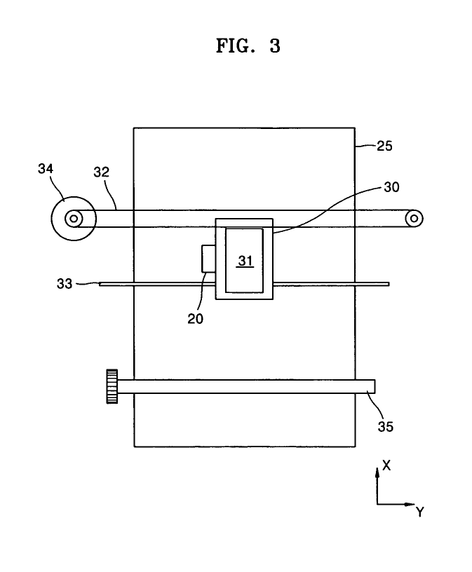

FIG. 3 is a plan view illustrating a configuration of a portion of an inkjet printer including the printing medium discriminator of FIG. 2. Referring to FIG. 3, the inkjet printer may include a carriage 30 positioned above a paper guide 53 of FIG. 5 on which the sheet of paper 25 is placed. The carriage 30 can move in a main scanning direction (Y direction) perpendicular to a paper feeding direction (X direction).

An inkjet cartridge 31 can be mounted on the carriage 30. When the printer is a monochrome printer, a single black inkjet cartridge can be mounted on the carriage 30. When the printer is a color inkjet printer, a black cartridge and a three-color inkjet cartridge can be mounted side by side on the carriage 30 or a combination of a black cartridge, a first color cartridge, and a second color cartridge can be mounted on the cartridge 30. A printhead (not shown) including a plurality of nozzles (not shown) can be disposed on a bottom of the inkjet cartridge 31. One end of the carriage 30 can be fixedly coupled to a travelling belt 32. Another end of the carriage 30 can slide along a guide rail 33 and can be shuttled in the Y direction by an electronic motor 34 driving the travelling belt 32.

The media sensor 20 can be attached to the cartridge 30 to discriminate the sheet of paper 25 on the paper guide 53 and can move when the carriage 30 moves. The sheet of paper 25 can be moved in a sub scanning direction (X direction) by a feeding roller 35.

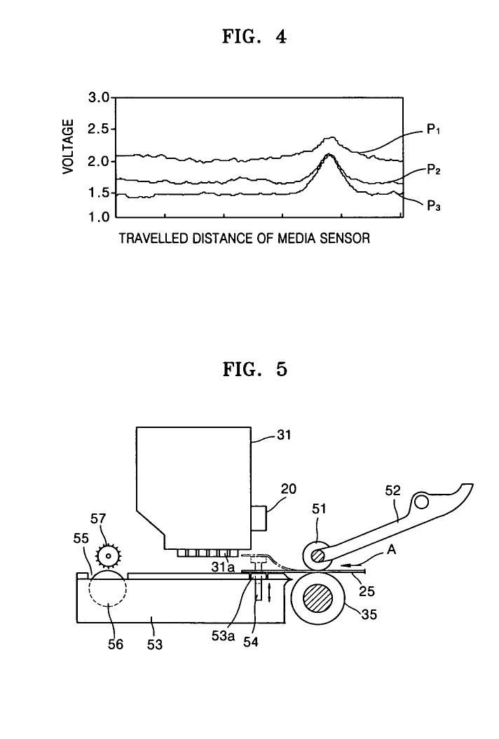

FIG. 4 is a graph illustrating voltages output from the light receiver 22 of the media sensor 20 while the media sensor 20 is moving in the main scanning direction. The light source 21 of the media sensor 20 can radiate light onto the sheet of paper 25. The light diffusedly reflected onto the light receiver 22 was measured. The sheet of paper 25 was then moved upward so that the light receiver 22 could receive the regularly reflected light. Glossy paper P₁, paper for an inkjet printer P₂, and plain paper P₃ were used as printing media.

Referring to FIG. 4, at the position where the regularly reflected light is incident on the light receiver 22, the voltage corresponding to the glossy paper P₁ was largest. The voltages corresponding to the paper for inkjet printer P₂ and the plain paper P₃ were similar to each other. At the position where the diffusedly reflected light is incident on the light receiver 22, the voltage corresponding to the paper for inkjet printer P₂ was larger than that corresponding to the plain paper P₃.

Table 1 is an example of a standard for discriminating types of printing media using the media sensor 20.

TABLE 1

| | | Irregular | Difference between diffused |
|---|---|---|---|
| | Reference | reflection | reflection voltage and regular |
| Paper | Numeral | voltage | reflection voltage |
| Glossy Paper | P1 | 1.9 or higher | — |
| Paper for Inkjet | P2 | 1.6˜1.9 | Less than 0.5 |
| Printer | | | |
| Plain Paper | P3 | 1.6 or lower | Greater than 0.5 |

FIG. 5 is a side view illustrating a portion of an inkjet printer including a printing medium discriminator according to another embodiment of the present invention. Referring to FIG. 5, a friction roller 51 can be disposed on a feeding roller 35 to contact the feeding roller 35, which supplies a sheet of paper 25 fed from a pick-up roller (not shown) to a printing area in a direction indicated by an arrow A along a paper path. The friction roller 51 can be rotatably connected to an end of a friction roller holder 52. The other end of the friction roller holder 52 is connected to the body of the printer.

At a downstream from the feeding roller 35 in a printing path, an inkjet cartridge 31 and a paper guide 53 spaced-apart by a predetermined distance from a printhead 316i a disposed on the bottom of the inkjet cartridge 31 to support the sheet of paper 25 can be installed. A slit 53a or a groove with a predetermined length can be formed on the paper guide 53 along the main scanning direction. A unit for vertical movement of the sheet of paper 25 can be installed at the slit 53a or the groove to move the sheet of paper toward a media sensor 20 or in a vertical direction. The vertical movement unit may be a cylinder rod 54 to move vertically by an actuator (not shown). The cylinder rod 54 can control the sheet of paper 25 to move toward the media sensor 20 or in the vertical direction.

The media sensor 20 can be installed on a side of the inkjet cartridge 31 to face the feeding roller 35. The cylinder rod 54 may be located directly below the media sensor 20. The structure of the media sensor 20 can be the same as shown in FIG. 2.

A plurality of grooves 55 can be formed on an end portion of the paper guide 53. An ejecting roller 56 can be disposed in the grooves 55, and a star wheel 57 can be disposed on the ejecting roller 56.

An operation of the printing medium discriminator of the inkjet printer will now be described with reference to FIGS. 2 and 5. First, the sheet of paper 25 picked up by the pick-up roller (not shown) can pass between the friction roller 51 and the feeding roller 35. The sheet of paper 25 can be forced into the printing path by a friction between the feeding roller 35 and the sheet of paper 25. The light source 21 of the media sensor 20 can radiate light onto the sheet of paper 25, and the light receiver 22 can receive light reflected from the sheet of paper 25, that is, the diffusedly reflected light.

By driving an actuator, the cylinder rod 54 can be moved upward by a predetermined height, thereby raising a position of the sheet of paper 25 as shown in FIG. 5. The media sensor 20 can receive light reflected from the sheet of paper 25, that is, the regularly reflected light. The intensity of the diffusedly reflected light and that of the regularly reflected light can be compared with the values in Table 1. Then, a type or characteristic of a printing medium being used can be determined.

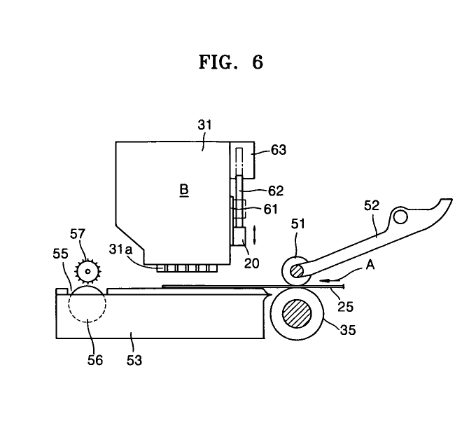

FIG. 6 is a side view illustrating a portion of an inkjet printer including a printing medium discriminator according to another embodiment of the present general inventive concept. A detailed description of elements of this embodiment of the present invention that are identical to elements of the previous embodiment of FIG. 5 are omitted. Elements of this embodiment that are identical to elements of the previous embodiment of FIG. 5 have identical reference numerals to the reference numerals of elements of the previous embodiment.

Referring to FIG. 6, a linear guide 61 can be vertically placed on one side of an inkjet cartridge 31, and a media sensor 20 can be placed on the linear guide 61. The media sensor 20 can be connected to an actuator 63 fixedly coupled to the inkjet cartridge 31 by a cylinder rod 62 connected to the media sensor 20. The media sensor 20 and the cylinder rod 62 do not necessarily have to be disposed on a side of the inkjet cartridge 31 to face a feeding roller 35. In other words, the media sensor 20 and the unit for vertical movement in the media sensor 20 may be disposed on a side B of the inkjet cartridge 31 or on a side of the inkjet cartridge 31 closest to an ejecting roller 56. The media sensor 20 can be used as an automatic alignment sensor.

The operation of the printing medium discriminator of the inkjet printer will now be described in detail with reference to FIGS. 2 and 6. First, the sheet of paper 25 fed from a pick-up roller (not shown) can pass between the rotating friction roller 51 and the feeding roller 35. The sheet of paper 25 can be forced into the printing path by friction between the feeding roller 35 and the sheet of paper 25. The light source 21 of the media sensor 20 can radiate light onto the sheet of paper 25, and the light receiver 22 can receive the light reflected from the sheet of paper 25, that is, the diffusedly reflected light.

By driving the actuator 63, the cylinder rod 54 can be moved downward by a predetermined distance, thereby decreasing the distance between the cylinder rod 54 and the sheet of paper 25. At this time, the media sensor 20 can radiate the light onto the sheet of paper 25 and can receive the light reflected from the sheet of paper 25, that is, the regularly reflected light. The intensity of the diffusedly reflected light and that of the regularly reflected light can be compared with the values in Table 1. Then, a type or characteristic of a printing medium to be used can be determined.

As described above, a printing medium discriminator according to embodiments of the present invention using a media sensor including one light receiver effectively discriminates types of printing media.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A printing medium discriminator to discriminate a type of a sheet of paper, comprising:
a media sensor separated by a predetermined height from the sheet of paper to radiate light onto the sheet of paper and to receive light reflected from the sheet of paper; and
a unit to adjust a vertical height between the media sensor and the sheet of paper.

2. The printing medium discriminator of claim 1, wherein the media sensor comprises:
a light source to radiate the light onto the sheet of paper at a predetermined angle; and
a light receiver to receive the light reflected from the sheet of paper, and the light receiver receives diffusedly reflected light and regularly reflected light, respectively, reflected from the sheet of paper according to the vertical height between the media sensor and the sheet of paper adjusted by the unit.

3. The printing medium discriminator of claim 2, wherein the light receiver is one light receiving element fixedly coupled to the media sensor.

4. The printing medium discriminator of claim 1, wherein the unit moves the sheet of paper vertically with respect to the media sensor.

5. The printing medium discriminator of claim 1, wherein the unit moves the media sensor vertically with respect to the sheet of paper.

6. An inkjet printer including a printing medium discriminator, comprising:
a carriage;
an inkjet cartridge mounted on the carriage, the carriage and the inkjet cartridge shuttling in a main scanning direction;
a feeding roller to feed a sheet of paper in a sub scanning direction;
a paper guide separated by a predetermined height from the inkjet cartridge and supporting the sheet of paper fed from the feeding roller such that the sheet of paper under the inkjet cartridge is flat;
a media sensor attached to the inkjet cartridge, separated a predetermined height from the sheet of paper, to radiate light onto the sheet of paper and to receive light reflected from the sheet of paper; and
a unit to adjust a vertical height between the media sensor and the sheet of paper.

7. The inkjet printer of claim 6, wherein the media sensor comprises:
a light source to radiate the light onto the sheet of paper at a predetermined angle and;
a light receiver to receive light reflected from the sheet of paper, and the light receiver receives diffusedly reflected light and regularly reflected light, respectively, reflected from the sheet of paper according to the vertical height between the media sensor and the sheet of paper adjusted by the unit for vertical movement.

8. The inkjet printer of claim 7, wherein the light receiver is one light receiving element fixedly coupled to the media sensor.

9. The inkjet printer of claim 6, wherein the unit moves the sheet of paper vertically with respect to the media sensor.

10. The inkjet printer of claim 9, wherein the paper guide comprises a slit, and the unit comprises:
a cylinder rod disposed in the slit formed in the main scanning direction on the paper guide; and
an actuator to move the cylinder rod vertically.

11. The inkjet printer of claim 9, wherein the media sensor is disposed on a side of the inkjet cartridge to face the feeding roller, and the unit is installed directly below the media sensor.

12. The inkjet printer of claim 6, wherein the unit moves the media sensor vertically with respect to the sheet of paper.

13. The inkjet printer of claim 12, wherein the unit comprises a linear guide vertically disposed on a side of the inkjet printer and an actuator to move the media sensor vertically, and the media sensor is disposed on the linear guide.

14. The inkjet printer of claim 13, wherein the media sensor comprises a print alignment sensor disposed on a side of the inkjet cartridge corresponding to the main scanning direction.

15. An inkjet printer including a printing medium discriminator, comprising:
a feeding unit to feed a sheet of paper in a sub scanning direction;
a media sensor to receive a first light and a second light reflected from the sheet of paper to discriminate the sheet of paper; and
a unit to change a distance between the media sensor and the sheet of paper so that the media sensor receives the first light and the second light according to the changed distance.

16. The inkjet printer of claim 15, wherein the changes distance comprises a first distance and a second distance, and the media sensor receives the first light and the second light when the media sensor is spaced-apart from the sheet of paper by the first distance and the second distance, respectively.

17. The inkjet printer of claim 15, wherein the media sensor receives the first light and the second light at a time interval.

18. The inkjet printer of claim 15, wherein the distance is in a direction having an angle with the sub scanning direction.

19. The inkjet printer of claim 15, wherein the distance is perpendicular to the sub scanning direction.

20. The inkjet printer of claim 15, wherein the unit controls the sheet of paper to move in a direction having an angle with the sub scanning direction.

21. The inkjet printer of claim 15, wherein the unit controls the media sensor to move toward the sheet of paper in a direction having an angle with the sub scanning direction.

22. The inkjet printer of claim 15, wherein the media sensor comprises a single light receiving sensor to receive the first light and the second light reflected from the same sheet of paper to determine a type of the sheet of paper.

23. The inkjet printer of claim 15, wherein the media sensor generates a first voltage and a second voltage corresponding to the first and the second light, so that a characteristic of the sheet of paper is determined according to the first voltage and the second voltage.

24. The inkjet printer of claim 15, further comprising:
a table to store values corresponding to types of printing media,
wherein the media sensor generates a first voltage and a second voltage corresponding to the first light and the second light, respectively, and a type of the sheet of paper is determined according to the values and the first and second voltages.

25. The inkjet printer of claim 15, wherein the media sensor comprises an automatic alignment sensor to detect an alignment state of the sheet of paper with respect to the sub scanning direction and to detect the first light and the second light reflected from the sheet of paper.

26. The inkjet printer of claim 15, wherein the distance comprises a first distance and a second distance and the media sensor comprises a light source to emit the light toward the sheet of paper and a single light receiving sensor spaced-apart from the sheet of paper by the first distance and the second distance by the unit to receive the first light and the second light.

27. The inkjet printer of claim 15, wherein the sheet of paper is a single sheet of paper, and the first light and the second light are light diffusedly and regularly reflected from the single sheet of paper at a time interval, respectively.
